(19) United States
(12) Patent Application Publication
(10) Pub. No.: US 2015/0152684 A1
(43) Pub. Date: Jun. 4, 2015

(54) Ladder Support

(71) Applicant: Daniel Scott Livermore, Houston, TX (US)

(72) Inventor: Daniel Scott Livermore, Houston, TX (US)

(21) Appl. No.: 14/513,596

(22) Filed: Oct. 14, 2014

Related U.S. Application Data
(60) Provisional application No. 61/910,380, filed on Dec. 1, 2013.

(51) Int. Cl. E06C 7/50; A01M 31/02; E06C 1/39

(52) U.S. Cl. CPC E06C 7/50; E06C 1/39; A01M 31/02

(57) ABSTRACT

The present application is directed to a ladder support for securing a ladder to a target columnar member. The ladder support includes arm members operationally configured to engage the target columnar member during operation.

### CROSS-REFERENCE TO RELATED APPLICATIONS

The application is entitled to the benefit of the filing date of the prior-filed provisional application number 61/910,380, filed on Dec. 1, 2013.

### STATEMENT REGARDING FEDERALLY SPONSORED RESEARCH OR DEVELOPMENT

Not applicable.

### FIELD OF THE APPLICATION

The application relates generally to ladder supports.

### BACKGROUND

Ladder supports are used commercially to brace ladders at or near their mid-point by forming a connection between a ladder and a target structure upon which the ladder is set during use, e.g., a ladder supported by a telephone pole, tree, etc. A known commercially available ladder support is illustrated in FIG. 1. As shown, the ladder support includes a predetermined maximum/minimum length, meaning that a direct correlation necessarily exists between the length of the ladder support and the maximum/minimum distance of the base of the ladder from the target structure. Likewise, ladder supports like the one depicted in FIG. 1 are limited for use on structures that are substantially vertically oriented because non-vertically oriented target structures create spacing and/or bracing problems for such ladder supports.

Overcoming such disadvantages is desired.

### SUMMARY

The present application is directed to a ladder support for securing a ladder to a target columnar member, the ladder support including arm members operationally configured to engage differing surfaces of the target columnar member.

The present application is also directed to a ladder support assembly for engaging a target columnar member supporting a corresponding ladder, the assembly having opposing arm members independently pivotally attached to the ladder and extending out from the ladder in a manner whereby the target columnar member is disposed between the arm members.

The present application is also directed to a tree stand system, including (1) a ladder having a proximal end for engaging a support surface and a distal end defined by one or more platforms operationally configured to engage a front surface of a target tree; and (2) a ladder support assembly including two or more arm members pivotally attached to the ladder and extending out from the ladder in substantially planar alignment beyond the front surface of the tree, the arm members being operationally configured to engage a tree in a manner effective to fix the ladder in a static position, the support assembly being operationally configured to adjust the ladder angle from horizontal without altering the length of the arm members.

### BRIEF DESCRIPTION OF THE SEVERAL VIEWS OF THE DRAWING

FIG. 1 is a simplified view of a known ladder support in use with a simplified hunter's tree stand. As shown, the tree stand includes a ladder member 1A, a standing platform 1B and a seating platform 1C in an engagement position with a target tree 1D. The ladder support 1E extends from a rung of the ladder member 1A to an engagement position with the tree 1D. A strap 1F is used to assist in holding the ladder support 1E in a fixed position against the target tree 1D.

FIG. 2A is a simplified perspective view of a ladder support in operation with a tree stand and tree trunk leaning in a direction toward the ladder.

FIG. 2B is a simplified perspective view of a ladder support in operation with a tree stand and tree trunk leaning in a direction away from the ladder.

FIG. 2C is a simplified perspective view of a ladder support in operation with a tree stand and tree trunk leaning in a direction sideways to the ladder.

FIG. 3 is a simplified perspective view of another embodiment of a ladder support of the present application in operation with a tree stand and a non-linear tree trunk.

FIG. 4A is a simplified exploded top view of an embodiment of a ladder support assembly and a sectional view of a simplified tree trunk.

FIG. 4B is a simplified perspective view of an arm connector of the application.

FIG. 4C is a perspective view of a section of a ladder illustrating extension members attached thereto.

FIG. 4D is a view of a simplified hinged clamp device illustrating an arm member attached thereto.

FIG. 5 is a side exploded view of another simplified embodiment of a ladder support connected to a ladder.

FIG. 6 is a top exploded view of another simplified embodiment of a ladder support and columnar member.

FIG. 7 is a top view of another simplified embodiment of a ladder support.

FIG. 8 is a perspective view of a simplified embodiment of an arm member of a ladder support.

FIG. 9 is a perspective view of a simplified embodiment of an extension member of a ladder support.

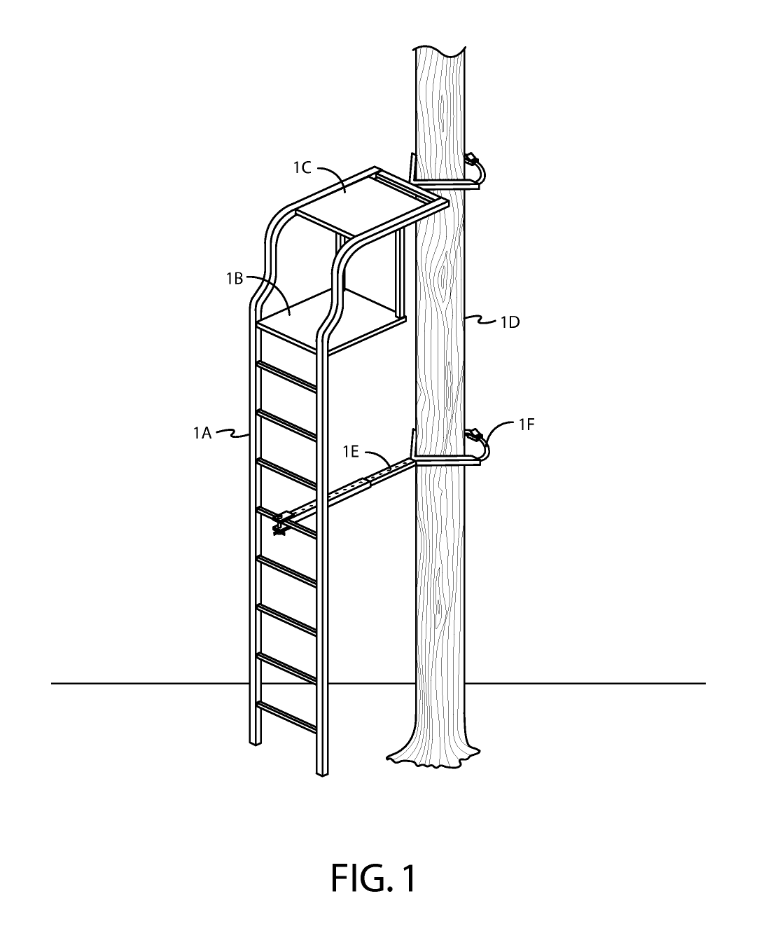

### DETAILED DESCRIPTION

A novel approach for supporting a ladder during use has been discovered. Heretofore, such a desirable achievement has not been considered possible, and accordingly, the approach of this application measures up to the dignity of patentability and therefore represents a patentable concept.

Before describing the invention in detail, it is to be understood that the present approach is not limited to particular embodiments. It is also to be understood that the terminology used herein is for the purpose of describing particular embodiments only, and is not intended to be limiting. As used in this specification and the appended claims, the term “columnar member” refers to a structure having a shape substantially similar to a curved surface or multi-sided column, post, pole, tree trunk, and the like, which rises up from a support surface to a particular height.

In one aspect, the application provides a ladder support operationally configured to be attached to a columnar member supporting a corresponding ladder in a manner effective to adjust the ladder angle from horizontal while bracing the ladder and without altering the length of the ladder support.

In another aspect, the application provides an assembly operationally configured to be attached to a columnar member supporting a corresponding ladder in a manner effective to adjust the ladder angle from horizontal while bracing the ladder and without altering the length of the ladder support.

In another aspect, the application provides a ladder support operationally configured to be secured to a plurality of columnar members having varying outer surface configurations and/or sizes.

In another aspect, the application provides a ladder support operationally configured to prevent ladder slippage during use.

In another aspect, the application provides a ladder support operationally configured to be secured to a plurality of columnar members of varying outer surface widths or dimensions used to support a ladder during use. In one embodiment, the ladder support may include arm members extending out from a ladder and contacting surfaces of the target columnar member from (1) about 55.0 degrees to about 125.0 degrees and (2) about 235.0 to about 305.0 degrees relative the point of contact of the ladder with the surface of the columnar member.

In another aspect, the application provides an assembly operationally configured to be secured to a plurality of columnar members of varying outer surface configurations. Target columnar members may vary in width ranging from a width less than the distance between the side rails of the corresponding ladder to a width greater than the distance between the side rails of the corresponding ladder.

In another aspect, the application provides an assembly operationally configured to be secured to one or more columnar members of varying outer surface widths or dimensions.

In another aspect, the application provides a hunter's tree stand including a ladder having one or more platforms at a distal end of the ladder for engaging a columnar member and a ladder support operationally configured to hold the ladder in a substantially fixed position in relation to the columnar member.

In another aspect, the application provides a ladder support including two or more arm type members pivotally or statically attachable to a ladder at proximal ends and extendable out from the ladder in a substantially parallel manner whereby the distal ends of the arms are unobstructed by a target columnar member upon which the corresponding ladder is supported. In one aspect, the arm members may be operationally configured to apply equal and opposing forces to opposing surfaces of a target columnar member.

In another aspect, the application provides a ladder support including two or more arm type members pivotally or statically attachable to a ladder at proximal ends and extendable out from the ladder in a substantially non-parallel manner whereby the distal ends of the arms are unobstructed by a target columnar member upon which the corresponding ladder is supported.

In another aspect, the two or more arm type members may lie in substantially planar alignment or non-alignment as desired or otherwise required.

In another aspect, the application provides a method for altering the ladder angle from horizontal of a ladder being supported by a columnar member without altering the length of the ladder support connecting the ladder to the columnar member.

In another aspect, the application provides a ladder support assembly having arm type extension members effective to sandwich a columnar member there between.

In another aspect, the application provides a ladder support including arm members releasably attachable to opposing side rails of a ladder. In another aspect, the arm members may be pivotally attached to side rails of a ladder. In still another aspect, the arm members may include one or more bracing members disposed there between effective to prevent ladder rotation during ladder use.

In another aspect, the application provides a ladder support having (1) arm members and (2) extension members releasably attachable to each of the arm members. In one embodiment, the arm members and extension members are operationally configured to engage differing surfaces of a target columnar member, including but not necessarily limited to surfaces about equal in altitude or height along the length of the target columnar member.

In another aspect, the application provides a ladder support having arm members with first ends attachable to a ladder, the arm members being defined by gripping surfaces operationally configured to engage a target columnar member supporting a corresponding ladder. In another aspect, the ladder support may include extension members defined by gripping surfaces operationally configured to engage a target columnar member during operation of the ladder support. The gripping surfaces may include planar surfaces, non-planar surfaces, serrations, resilient surfaces, tacky surfaces, deformable surfaces, and combinations thereof.

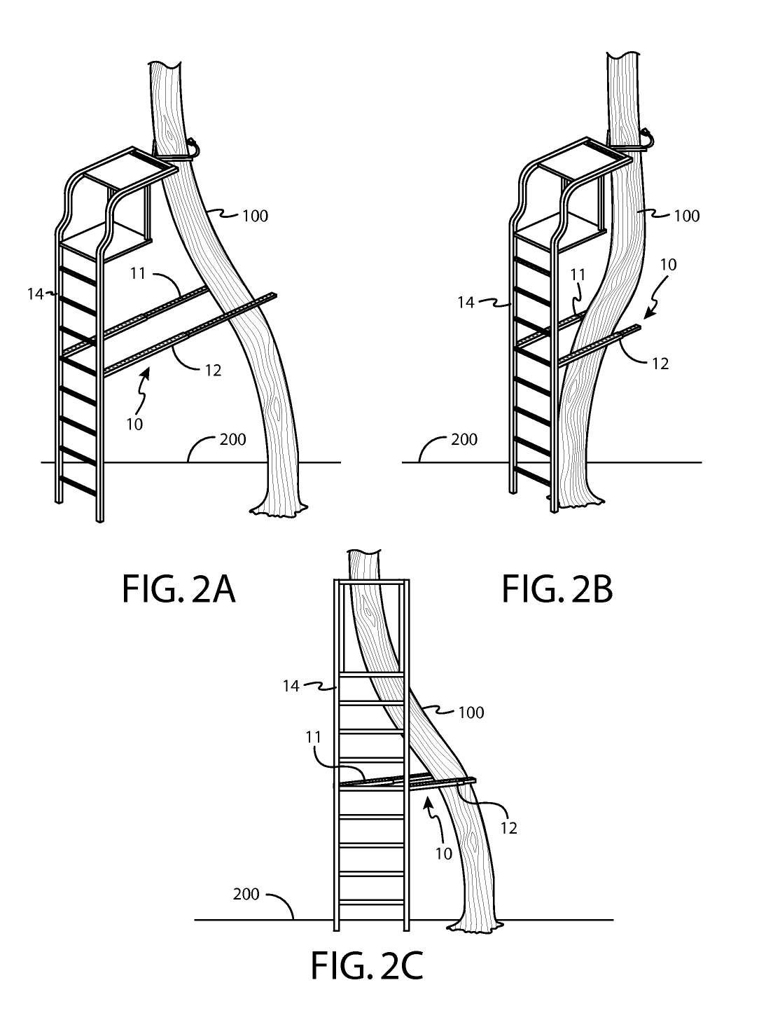

To better understand the novelty of the present approach, reference is hereafter made to the accompanying drawings. With attention to FIGS. 2A-2C, a simplified embodiment of a ladder support 10 is provided. Here shown, the ladder support 10 includes at least dual arm members 11, 12 attached to a ladder 14 at proximal ends, the arm members 11, 12 extending out from a ladder 14 in a substantially parallel and planar orientation whereby the arm members 11, 12 are operationally configured to engage opposite sides of a target columnar member 100. In other embodiments, the arm members 11, 12 may be oriented in (1) a non-parallel orientation, e.g., where a columnar member 100 has a width greater than the attachment points of arm members 11, 12 along a ladder 14 or vice-versa, and (2) a non-planar orientation wherein the distal end of one arm member is set at a greater altitude or height than the other arm member.

As discussed below, the arm members 11, 12 may be permanently or releasably attached to the side rails of a ladder 14, the rungs of a ladder 14, and a combination thereof. In one embodiment, the arm members 11, 12 may be pivotally attached about the side rails of the ladder 14 as desired. In another embodiment, the arm members 11, 12 may be pivotally attached to a rung of a ladder 14 as desired. The arm members 11, 12 may also be operationally configured to be adjusted along the length of the side rails of a ladder 14 thereby adjusting the position of the ladder support 10 along a ladder 14 as may be desired for one or more particular applications.

As FIGS. 2A-2C illustrate, by providing a ladder support 10 effective to engage opposites sides of a columnar member 100 the placement of the base of the ladder 14 along a support surface 200 is not limited to a particular minimum/maximum distance relative to the columnar member 100. In other words, the ladder angle from horizontal may change without the necessity of adjusting the length of the ladder support 10 or without having to replace one ladder support 10 for another ladder support of greater or lesser length. Also, a suitable ladder support 10 is effective for maintaining the ladder angle from horizontal regardless of the orientation of the columnar member 100—see for example FIGS. 2A and 2B, which show columnar members 100 in the forming of tree trunks leaning forward toward the ladder 14 (FIG. 2A) and backward away from the ladder 14 (FIG. 2B). Likewise, the present ladder support 10 may be effective for use with a ladder 14 supported by a sideways type leaning columnar member 100 by providing arm members 11, 12 pivotal about the ladder 14 (see FIG. 2C). Moreover, when used with a hunter's tree stand, the present ladder support 10 is effective to be secured to one or more columnar members 100 of various vertical orientations in a manner effective to orient the seating and/or standing platforms of the hunter's tree stand as desired.

To optimize engagement of the arm members 11, 12 with a target columnar member 100, engagement surfaces of the arm members 11, 12 may be provided with one or more surface configurations and/or materials of construction as desired. Moreover, the engagement surfaces of the arm members 11, 12 may have particular surface areas as desired. Engagement surfaces of the arm members 11, 12 may also be constructed from one or more resilient materials and/or form fitting materials as desired. For example, in an embodiment where a target columnar member 100 is comprised of wood, the engagement surfaces of the arm members 11, 12 may include wood grabbing elements disposed along the engagement surfaces thereof. Suitable wood grabbing elements may include, but are not necessarily limited to diamond plate tread, teeth, serrated edges, bumps, protrusions, and combinations thereof. In an embodiment where a target columnar member 100 is constructed from metal, the engagement surfaces of the arm members 11, 12 may include one or more polymeric surfaces operationally configured to engage the surface of the columnar member 100 in a manner effective to secure the engagement surfaces against the columnar member 100 in a non-slip fashion. Suitable polymeric materials may include, but are not necessarily limited to plastics, rubbers, foam plastics, foam rubbers, and combinations thereof. Suitable rubbers may include natural rubbers, synthetic rubbers, and combinations thereof. Additives such as carbon black may also be added to rubbers and plastics as desired. In another simplified example, the arm members 11, 12 may include engagement surfaces covered by silicone rubber operationally configured to form fit with the outer surface shape of a target columnar member 100. Exemplary shapes of arm members 11, 12 may include oblong and/or cylindrical and/or irregular shaped and/or multi-sided members.

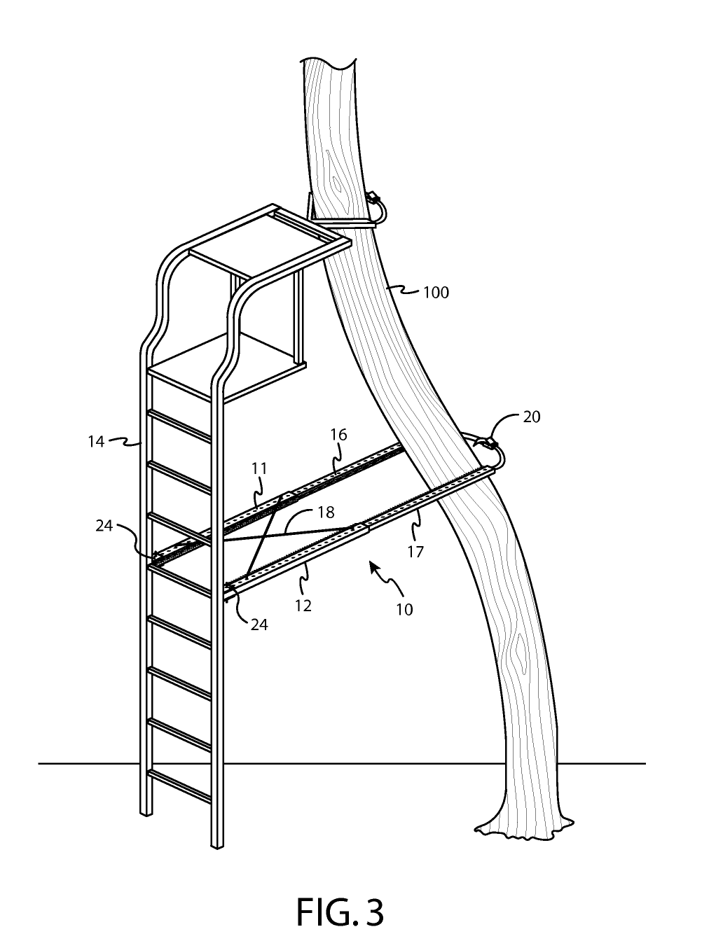

Turning to FIG. 3, the ladder support 10 may also include extension members 16, 17 attachable to arm members 11, 12 and operationally configured to extend out from the arm members 11, 12 in a manner effective to extend the useful length of the ladder support 10. Suitably, extension members 16, 17 may be attached to the arm members 11, 12 in a manner effective to maintain structural strength of the ladder support 10 during use. As such, extension members 16, 17 may include shapes and/or engagement surfaces similar as the arm members 11, 12 as described above. In one embodiment, extension members 16, 17 may be telescopically attached to corresponding arm members 11, 12. In another embodiment, extension members 16, 17 may be coupled to corresponding arm members 11, 12 as desired via one or more clamps, braces, sleeves, adhesive, pins, and combinations thereof.

Still referring to FIG. 3, the ladder support 10 may include one or more bracing members 18 or bracing assemblies disposed between arm members 11, 12 and/or extension members 16, 17 operationally configured to interconnect the arm members 11, 12 and/or the extension members 16, 17 as desired. In operation, the bracing members 18 are effective to fix or stabilize arm members 11, 12 and/or the extension members 16, 17 minimizing or otherwise preventing ladder 14 torsion. Thus, bracing members 18 of the present application are effective to improve operability of a ladder 14, especially when used with a non-vertically oriented target columnar member 100.

The bracing members 18 may also provide support against tension and/or compression being applied to the ladder support 10 during use. For example, in an embodiment as shown in FIG. 2C, forces may be applied to the arm members 11, 12 and/or the extension members 16, 17 unequally, which may cause a ladder 14 to rotate about the columnar member 100. Thus, the one or more bracing members 18 are suitably effective to distribute forces across the arm members 11, 12 and/or the extension members 16, 17 in a manner effective to resist twisting and/or sliding of the arm members 11, 12 and/or the extension members 16, 17 in a manner effective to prevent or otherwise minimize ladder 14 rotation during ladder 14 use. Without limiting the bracing members 18 to a particular embodiment, suitable bracing members 18 may be provided as cross braces as shown in FIG. 3. In another embodiment, bracing members 18 may be disposed between arm members 11, 12 in a non-intersecting arrangement, e.g., a substantially parallel fashion and/or a substantially non-parallel fashion. Also, the one or more bracing members 18 may be attached to the arm members 11, 12 as desired. In one embodiment, bracing members 18 may be provided as rod-like members operationally configured to mate with holes on the inside surface of the arm members 11, 12 as desired. In another embodiment, rod-like members may include L-shape edges or appendages for mating with holes in the arm members 11, 12. In another embodiment, rod-like members may be threadedly attached to holes in the arm members 11, 12. In another embodiment, rod-like members may include retractable pins for mating with holes in the arm members 11, 12. In still another embodiment, bracing members 18 may be adhered to arm members 11, 12. For example, in an embodiment including metal component parts, bracing members 18 may be welded to arm members 11, 12. In another embodiment, clamps and the like may be employed to fix bracing members 18 to arm members 11, 12. In still another embodiment, bracing members 18 may be provided as strap material, e.g., ratchet straps. The above described bracing members 18 may also be used in a similar manner with extension members 16, 17 as desired.

With further reference to FIG. 3, the ladder support 10 may also include one or more linking members 20 for interconnecting the distal ends of the arm members 11, 12 or extension members 16, 17 in a manner effective to maintain the ladder support 10 in an engagement position with a columnar member 100. As FIG. 3 depicts, a linking member 20 may be located at a point about a columnar member 100 opposite the location of the corresponding ladder 14. In simplest terms, linking members 20 are effective to prevent the arm members 11, 12 or extension members 16, 17 from traveling off apart from the columnar member 100 during operation of the ladder support 10. In other words, linking members 20 are operationally configured to draw the arm members 11, 12 toward one another in a sandwiching type manner whereby the arm members 11, 12 apply a linear force to opposite sides of the columnar member 100 maintaining the ladder support 10 in a fixed position about the columnar member 100. Suitable linking members 20 may include, but are not necessarily limited to rope, tape, string, wire, chain link, bungee cords, ratchet straps, cam straps, tie straps, and combinations thereof. Depending on the type of linking member(s) 20 employed, the arm members 11, 12 and/or extension members 16, 17 may include apertures and/or hooks and/or loops and/or buckles and/or strap adjusters and/or swivel and rotate snaphooks for attachment of the linking member(s) 20 thereto.

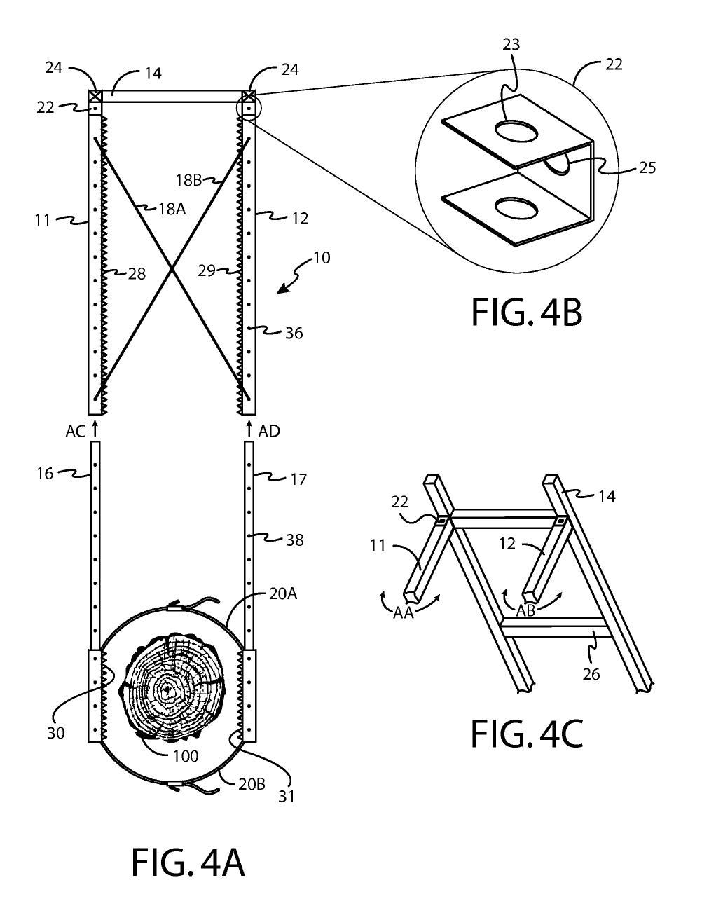

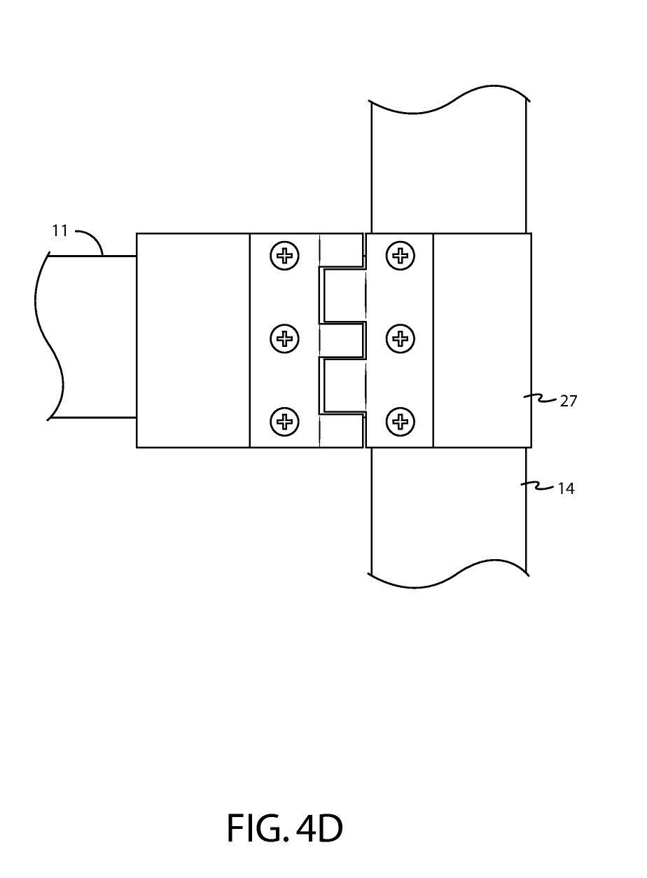

With attention to FIGS. 4A-4C, the ladder support 10 may also include arm connectors 22 operationally configured to releasably attach arm members 11, 12 to a ladder 14. In one suitable embodiment, arm connectors 22 may be provided as mounting brackets (see FIG. 4B) providing pivotal and releasable attachment of the arm members 11, 12 to a ladder 14 (see directional arrows AA and AB in FIG. 4C) via one or more locking pins, e.g., steel dowel pins, or other linkages for securing the arm members 11, 12 to the arm connectors 22 via apertures 23. As illustrated, arm connectors 22 may be attached to the side rails 24 of a ladder 14 using a fastener via aperture 25. The arm connector 22 of FIG. 4B is shown as having a substantially planar back surface for abutting a substantially planar surface of a ladder side rail 24. In another embodiment, the arm connector 22 may include a curved shape for abutment with a curved surface of a side rail 24. Also, the arm connector 22 may be configured to allow for vertical arm member movement, e.g. a mounting bracket defined by angles greater than about 90.0 degrees. In another embodiment, one or more arm connectors 22 may be attached to rungs 26 of a ladder 14 as desired.

In the embodiment of FIG. 4A, the ladder support 10 is operationally configured for use with a pre-existing ladder, including a ladder of a known tree stand. In such embodiment, the arm connectors 22 may be fastened or clamped to the ladder 14 as desired. In another embodiment where the ladder support 10 and ladder 14 are provided as a single or collective manufactured unit, arm connectors 22 may be provided as separate or as an integral part of the ladder 14, e.g., permanent attachment thereto via welds and/or fasteners, whereby the ladder support 10 may be releasably attached to the arm connectors as described above. In another embodiment, the arm members 11, 12 may be attached to the ladder 14 in another manner, for example, the proximal ends of the arm members 11, 12 may be operationally configured for pivotal attachment to the ladder 14 via hinged clamps 27 as shown in FIG. 4D. In another example, the arm members 11, 12 may include shoulders surrounding the side rails 24 in a pivotal connection thereto. For ease of transport, packaging, shipping, storing and shelving the ladder support 10, the arm members 11, 12 may be provided as releasable from the ladder 14.

Still referring to the simplified embodiment of FIG. 4A, the ladder support 10 may be provided as an assembly of member parts, including for example, (1) arm connectors 22, (2) arm members 11, 12 defined by serrated engagement surfaces 28, 29, as well as optional (3) bracing members 18A, 18B, (4) extension members 16, 17 telescopically attachable to the arm members 11, 12 (see directional arrows AC and AD)—the extension members also having serrated engagement surfaces 30 and 31 and (5) linking members 20A and 20B effective for assisting with securing the ladder support 10 to a columnar member 100 in a fixed position.

In the embodiment of FIG. 4A, the extension members 16, 17 include engagement surfaces 30, 31 near their distal ends—the remaining part of the extension members 16, 17 being operationally configured to mate with the arm members 11, 12 including an outer diameter or width less than the inner diameter or width of the arm members 11, 12 allowing the extension members 16, 17 to be directed and held within the arm members 11, 12. As further shown in FIG. 4A, the arm members 11, 12 and extension members 16, 17 may include apertures 36, 38 there through, Once the apertures are aligned, a locking pin, bolt or other device may be placed through corresponding apertures 36, 38 joining the extension members 16, 17 to the arm members 11, 12 in a fixed position. The apertures 36 along the arm members 11, 12 may also serve as connection locales for the one or more bracing members 18 as desired.

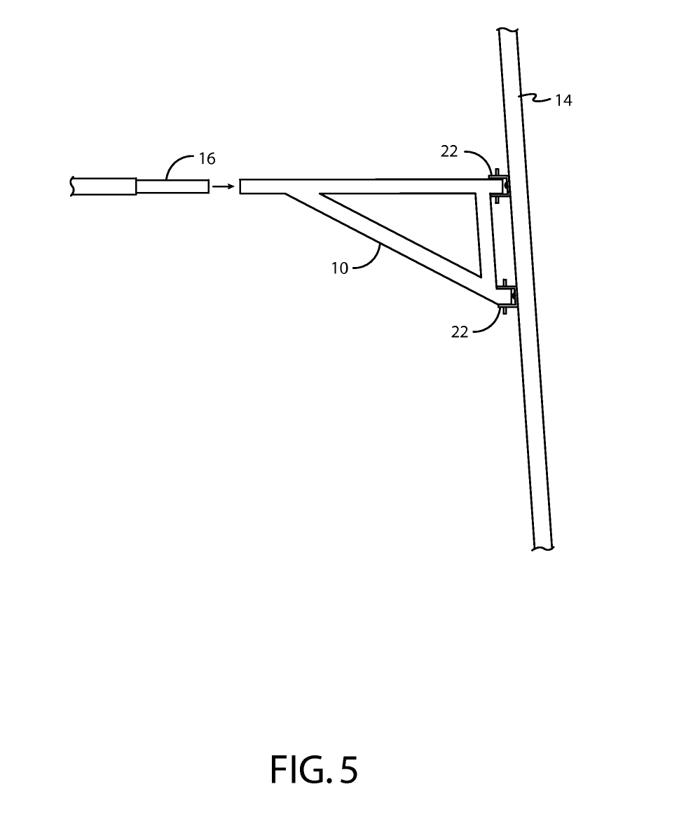

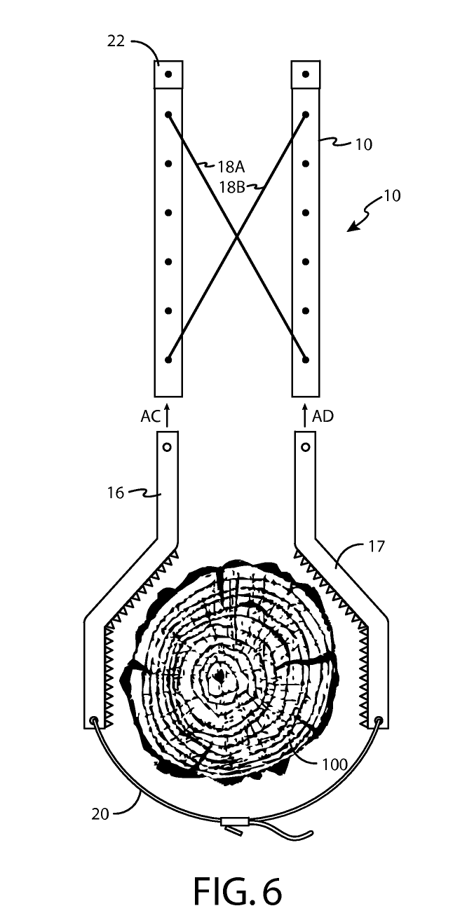

Turning to FIG. 5, another suitable ladder support 10 may include a triangular type bracing arrangement operationally configured to increase the structural strength of the ladder support 10 during use. In this embodiment, the ladder support 10 may be operationally configured to releasably mate with arm connectors 22 as described above. Other arrangements for increasing structural strength of the ladder support 10 may also be employed as desired. In another embodiment as shown in FIG. 6, the arm members 11, 12 and/or the extension members 16, 17 may include non-linear engagement surface configurations for substantially conforming to at least part of the outer surface of one or more particular columnar members 100 as desired.

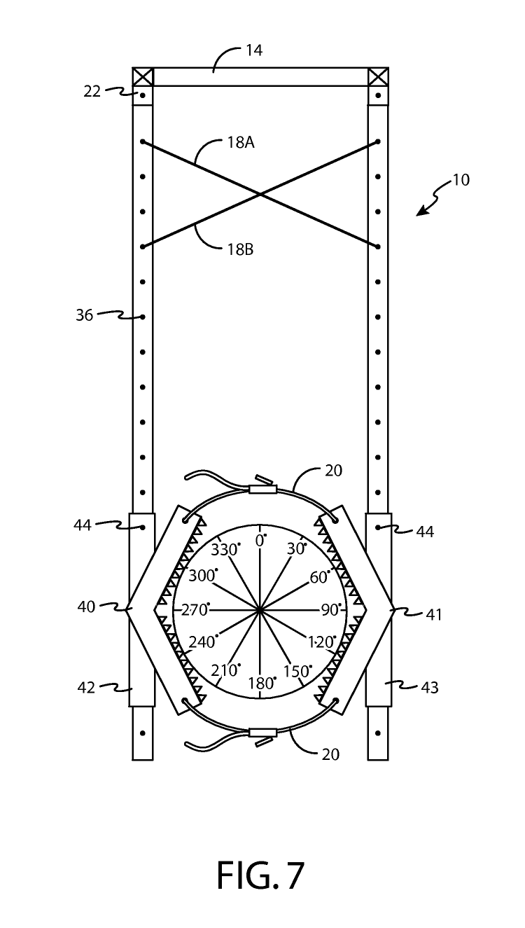

In still another embodiment, the arm members 11, 12 and/or extension members 16, 17 may include movable engagement members 40, 41 in communication thereto in a manner effective to (1) be directed along the length of the corresponding arm members 11, 12 and/or extension members 16, 17 engaging a columnar member 100 as desired. For example, in FIG. 7, the movable engagement members 40, 41 include sleeve members 42, 43 including apertures 44 there through effective for positioning and fixing the movable engagement members 40, 41 in a secure position relative to the arm members 11, 12 and/or extension members 16, 17 attached thereto. Similar as discussed above, once the apertures 44 are aligned with the apertures of either the corresponding arm members 11, 12 and/or extension members 16, 17, a locking pin or other device may be placed through both sets of apertures to hold the movable engagement members 40, 41 in a fixed position. Movable engagement members 40, 41 may be provided in one or more fixed shapes according to the surface orientation of one or more target columnar members 100. As shown in FIG. 7, the movable engagement members 40, 41 are depicted as multi-sectioned “V-shaped” members for engaging a cylindrical type columnar member 100. In other embodiments, the movable engagement members 40, 41 may be provided as linear members or curved members. In addition, the movable engagement members 40, 41 may be provided as adjustable and/or multi-part members, e.g., as slidable sections, pivotal sections, bendable sections, resilient sections, and combinations thereof, for adaptable use with varying surface configurations of columnar members 100. It is also contemplated that the surfaces of the several embodiments of the moveable engagement members 40, 41 be interchangeable.

In one simplified mode of operation, including a ladder support 10 for use with a pre-existing hunter's tree stand and ladder 14, an individual may attach arm connectors 22 to each of the side rails 24 of the ladder 14 at a desired point along the length of the ladder 14. Next, the individual may set the uppermost end of the tree stand against a target columnar member 100, e.g., a tree, per manufacturer recommendations, including a recommended ladder angle from horizontal. Once a ladder 14 is set in a desired upright position, the ladder support 10 may be attached to the ladder 14 by securing the arm members 11, 12 of the ladder support 10 to arm connectors 22 or hinged clamps 27—the arm members 11, 12 extending out from the ladder 14 in substantially planar alignment with the engagement surfaces of the arm members 11, 12 facing inward—a target columnar member 100 positioned there between. Next, the arm members 11, 12 may be further secured to the columnar member 100 via one or more linking members 20 in a manner effective to sandwich the columnar member 100 between the arm members 11, 12 securing the ladder support 10 in a fixed position stabilizing the hunter's tree stand and ladder 14. If it is desired to reposition the ladder angle from horizontal, the linking member 20 may be released and the base of the ladder 14 may be directed toward or away from the columnar member 100 whereby the corresponding arm members 11, 12 are directed along the outer edges of the columnar member 100 in the direction of the base of the ladder 14 regardless the position of the columnar member 100.

If the recommended ladder angle from horizontal causes the distance between the ladder 14 and columnar member 100 to be too great for use of a particular ladder support 10, extension members 16, 17 may be added to the distal ends of the arm members 11, 12 in a manner effective to extend the overall length of the ladder support 10 as necessary for securing the ladder support 10 to the columnar member 100.

For purposes of this application, suitable ladder support 10 assembly materials may include but are not necessarily limited to metals, plastics, rubbers, woods, fiberglass, plexiglass, filled composite materials, and combinations thereof. In particular, ladder support 10 assembly materials, may include but are not necessarily limited to, those materials resistant to chipping, cracking, excessive bending and reshaping as a result of ozone, weathering, heat, moisture, and other outside mechanical and chemical influences. Suitable metals may include, but are not necessarily limited to high carbon steel, low carbon steel, stainless steel, aluminum, aluminum alloys, iron, iron alloys, and combinations hereof. Suitable plastics may include, but are not necessarily limited to polyethylene, polypropylene, polyurethane, UV-stabilized polyethylene and combinations thereof Suitable composite materials may include, but are not necessarily limited to fiberglass reinforced polyester, fiberglass reinforced epoxy, aramid fibers such as KEVLAR® and carbon fiber composites. In one embodiment, the arm members and/or extension members may be constructed from one or more materials suitable for providing one or more substantially rigid arm members and/or extension members. In another embodiment, the arm members and/or extension members may be constructed from one or more materials suitable for providing one or more flexible arm members and/or extension members.

Suitably, the one or more bracing members 18 are constructed from materials strong enough to withstand extreme mechanical stresses. The bracing members 18 may also be constructed from corrosion-resistant materials having high axial tensile strength. In one embodiment including two cross bracing members 18, the bracing members 18 may be constructed from like material(s), or in the alternative, the bracing members 18 may be constructed from dissimilar materials as the remaining ladder support. 10. Suitable bracing member 18 materials may include, but are not necessarily limited to metals, woods, plastics, composite materials, and combinations thereof In an embodiment where bracing members 18 include ratchet straps, suitable straps may be constructed from one or more materials known to the skilled artisan, including, but not necessarily limited to synthetic fabric materials, natural fabric materials, rubbers, plastics, steel, hemp, nylon, cotton, polyester fiber, and combinations thereof Suitable metals may include, but are not necessarily limited to high carbon steel, low carbon steel, stainless steel, aluminum, aluminum alloys, iron, iron alloys, and combinations thereof Other exotic manufacturing metals, e.g., tantalum, titanium, and the like. are contemplated herein and will be appreciated by the skilled artisan. Suitable composite materials may include, but are not necessarily limited to glass fiber reinforced polyester, glass fiber reinforced epoxy, carbon fiber composite, and combinations thereof Other suitable composites are contemplated and will be appreciated by the skilled artisan.

### EXAMPLE 1

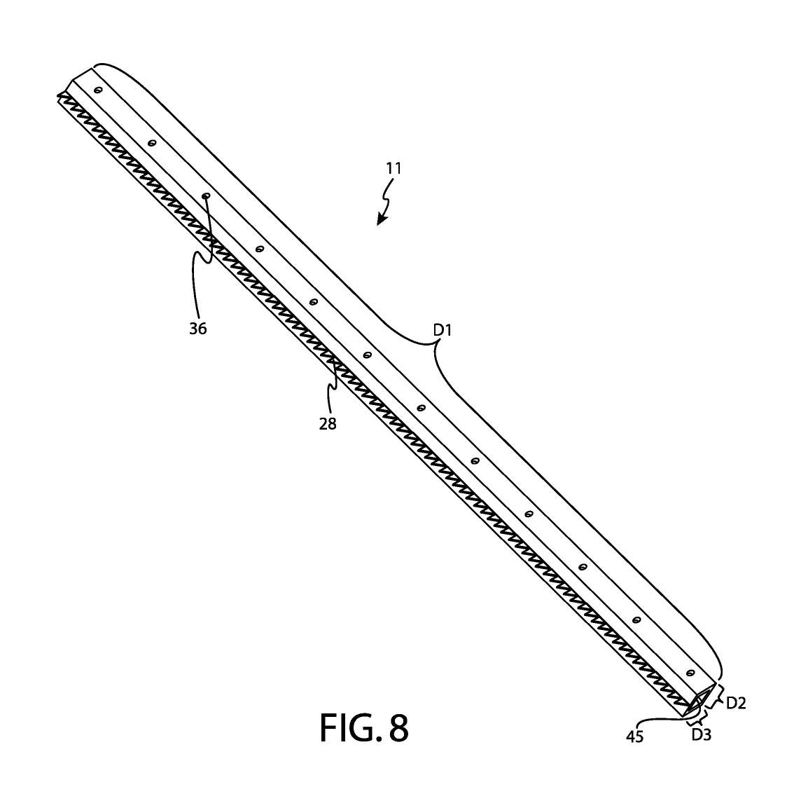

In a first non-limiting example, an arm member 11 of a ladder support 10 constructed from 6061 aluminum alloy is provided. With reference to FIG. 8, the arm member 11 may be described as follows:
D1: from about 121.9 cm (about 48.0 inches) to about 177.8 cm (about 70.0 inches)
D2: from about 1.27 cm (about 0.5 inches) to about 5.08 cm (about 2.0 inches)
D3: from about 1.27 cm (about 0.5 inches) to about 5.08 cm (about 2.0 inches)
Diameter of
Apertures 36: from about 0.64 cm (about 0.25 inches) to about 2.54 cm (about 1.0 inches)
Width of
Mouth 45: from about 0.94 cm (about 0.37 inches) to about 4.75 cm (about 1.87 inches).

### EXAMPLE 2

In a second non-limiting example, an arm member 11 of a ladder support 10 constructed from 16 gauge steel square tubing is provided. With reference to FIG. 8, the ladder support 10 may be described as follows:
D1: about 147.32 cm (about 58.0 inches)
D2: about 2.54 cm (about 1.0 inches)
D3: about 2.54 cm (about 1.0 inches)
Diameter of Apertures 36: about 0.95 cm (about 0.375 inches)
Width of Mouth 45: about 2.21 cm (about 0.87 inches).

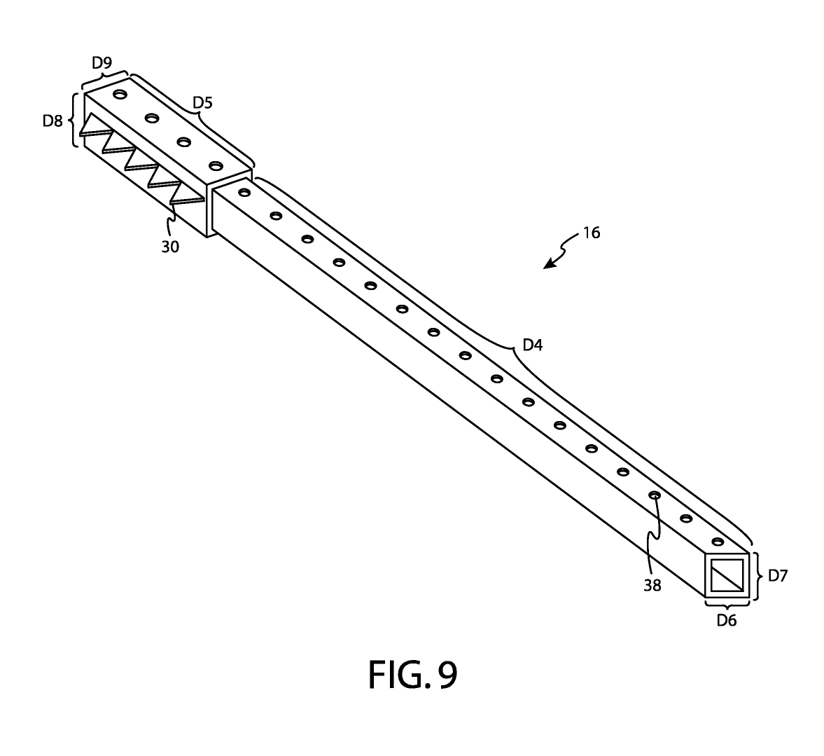

With reference to FIG. 9, a corresponding extension member 16 may be described as follows:
D4: about 137.2 cm (about 54.0 inches)
D5: about 40.6 cm (about 16.0 inches)
D6: about 1.91 cm (about 0.75 inches)
D7: about 1.91 cm (about 0.75 inches)
D8: about 2.54 cm (about 1.0 inches)
D9: about 2.54 cm (about 1.0 inches)

Persons of ordinary skill in the art will recognize that many modifications may be made to the present application without departing from the spirit and scope of the application.

The embodiment(s) described herein are meant to be illustrative only and should not be taken as limiting the invention, which is defined in the claims.

I claim:

1. A ladder support for securing a ladder to a target columnar member, the ladder support including arm members operationally configured to engage differing surfaces of the target columnar member.

2. The ladder support of claim 1 wherein the arm members are attachable to at least one of opposing side rails of a ladder, rungs of a ladder, and a combination thereof.

3. The ladder support of claim 2 wherein the arm members are pivotally attachable about the side rails.

4. The ladder support of claim 1 further including extension members releasably attachable to each of the arm members, the extension members being operationally configured to engage differing surfaces of the target columnar member.

5. The ladder support of claim 1 wherein the arm members include gripping surfaces operationally configured to engage the target columnar member during operation of the ladder support.

6. The ladder support of claim 4 wherein the extension members include gripping surfaces operationally configured to engage the target columnar member during operation of the ladder support.

7. The ladder support of claim 5 wherein the gripping surfaces may include planar surfaces, non-planar surfaces, serrations, resilient surfaces, tacky surfaces, and combinations thereof

8. The ladder support of claim 6 wherein the gripping surfaces may include planar surfaces, non-planar surfaces, serrations, resilient surfaces, tacky surfaces, and combinations thereof

9. The ladder support of claim 1 further including one or more bracing members disposed between the arm members effective to prevent ladder rotation during ladder use.

10. The ladder support of claim 4 further including one or more bracing members disposed between the arm members effective to prevent ladder rotation during ladder use.

11. The ladder support of claim 1 further including one or more linking members in communication with the arm members in a manner effective to apply opposing forces to the arm members.

12. The ladder support of claim 4 further including one or more linking members in communication with the extension members in a manner effective to apply opposing forces to the extension members.

13. The ladder support of claim 2 wherein a target columnar member may include a width ranging from a width less than the distance between the side rails of the ladder to a width greater than the distance between the side rails.

14. The ladder support of claim 1 further including engagement members moveable along the arm members and fixable thereto.
